(19) United States
(12) Patent Application Publication
(10) Pub. No.: US 2024/0402656 A1
(43) Pub. Date: Dec. 5, 2024

(54) ELECTRONIC DEVICE AND CONTROL METHOD FOR ELECTRONIC DEVICE

(71) Applicant: GOERTEK TECHNOLOGY CO., LTD, Qingdao, Shandong (CN)

(72) Inventors: Yanan ZHOU, Qingdao, Shandong (CN); Yan YANG, Qingdao, Shandong (CN); Huaiqing TIAN, Qingdao, Shandong (CN); Yong QIE, Qingdao, Shandong (CN); Junjie PAN, Qingdao, Shandong (CN)

(21) Appl. No.: 18/699,661

(22) PCT Filed: Jun. 30, 2022
(86) PCT No.: PCT/CN2022/102846

§ 371 Date: Apr. 9, 2024

(30) Foreign Application Priority Data
Dec. 30, 2021 (CN) 202111660426.6

(51) Int. Cl. G04G 17/04; G04G 17/08

(52) U.S. Cl. CPC G04G 17/04; G04G 17/08

(57) ABSTRACT

An electronic device, comprising: a housing; a rotation member rotatably connected to the housing; a first sensor used for detecting a rotation position of the rotation member; a second sensor used for detecting rotation information of the rotation member, wherein the rotation information comprises any one of rotation direction, rotation angle and rotation speed, or any combination thereof; and a processor respectively connected to the first sensor and the second sensor and used for performing corresponding operations according to the rotation position and/or rotation information. According to the present application, when it is inconvenient for a user to use a screen or buttons to control the electronic device, the rotation member can be used to realize control; and the convenience of device control can be improved. Further disclosed is a control method for an electronic device.

The present application claims the priority to the Chinese Patent Application No. 202111660426.6, entitled “Electronic Device and Control Method for Electronic Device”, submitted to the China Patent Office on Dec. 30, 2021, the entire content of which is incorporated herein by reference.

### TECHNICAL FIELD

The present application relates to the field of electronic device, and particularly, to an electronic device and a control method for the electronic device.

### BACKGROUND

With the rapid improvement of informatization level, smart wearable devices such as smart watches are becoming more and more popular. There are more and more scenarios where people use smart wearable devices in their daily lives. Smart wearable devices generally use a combination of buttons and touch screens to operate. However, when users wear smart wearable devices to wash hands or swim, the screen becomes wet or immersed in water, causing the touch screen to become inoperable, and complex operations cannot be performed by relying on the buttons alone.

Therefore, how to improve the convenience of device control is a technical problem that those skilled in the art currently need to solve.

### SUMMARY

The purpose of the present application is to provide an electronic device and a control method for the electronic device, which can improve the convenience of device control.

In order to solve the above technical problem, the present application provides an electronic device, including:
a housing;
a rotation member rotatably connected to the housing;
a first sensor configured to detect a rotation position of the rotation member;
a second sensor configured to detect rotation information of the rotation member; wherein the rotation information includes any one of a rotation direction, a rotation angle and a rotation speed, or any combination thereof; and
a processor respectively connected to the first sensor and the second sensor and configured to determine whether the rotation position is a preset position, and to perform a corresponding operation according to the rotation position and/or the rotation information.

Optionally, the processor is further configured to send a rotation detection instruction to the second sensor when the rotation position is the preset position;
the second sensor is configured to detect the rotation information of the rotation member after receiving the rotation detection instruction.

Optionally, the housing is provided with a gear mark, and the rotation member is provided with a rotation mark; wherein the gear mark is configured to indicate whether the rotation mark is rotated to the preset position.

Optionally, the number of the preset position is greater than one.

Optionally, the rotation member is provided with a magnetic component; and correspondingly, the first sensor is a magnetic sensor.

Optionally, the magnetic sensor is a three-axis Hall sensor.

Optionally, the second sensor is an optical tracking sensor.

Optionally, the electronic device is a smart watch, the rotation member is a watch bezel, and the watch bezel is rotatably disposed outside a part of the housing.

Optionally, the processor is further configured to control the processor to enter a sleep state and control the first sensor to enter a low power consumption detection mode when the rotation position is not the preset position.

Optionally, the electronic device further includes display, and a process for the processor to perform the corresponding operation according to the rotation position and/or the rotation information includes:
determining whether the rotation position is the preset position; if so, controlling the display to display an application menu corresponding to the preset position; wherein the application menu includes multiple application icons; and/or
obtaining the rotation information collected by the second sensor, and adjusting the currently selected application icon in a display screen of the display according to the rotation information.

Optionally, after the processor adjusting the selected application icon in the display screen according to the rotation information, the performed operation further includes:
if an application start instruction is received, starting an application corresponding to the currently selected application icon in the display screen; and/or,
if the rotation information does not change within a preset time, starting the application corresponding to the currently selected application icon in the display screen.

The present application also provides a control method for an electronic device, wherein the electronic device includes a housing and a rotation member rotatably connected to the housing, and the control method includes:
detecting a rotation position of the rotation member;
detecting rotation information of the rotation member; wherein the rotation information includes any one of a rotation direction, a rotation angle and a rotation speed, or any combination thereof;
determining whether the rotation position is a preset position, and performing a corresponding operation according to the rotation position and/or the rotation information.

The present application provides an electronic device, including: a housing; a rotation member rotatably connected to the housing; a first sensor configured to detect a rotation position of the rotation member; a second sensor configured to detect rotation information of the rotation member, wherein the rotation information includes any one of rotation direction, rotation angle and rotation speed or any combination thereof; a processor respectively connected to the first sensor and the second sensor and configured to determine whether the rotation position is a preset position, and to perform corresponding operations according to the rotation position and/or the rotation information.

The electronic device according to the present application includes a housing, a rotation member, a first sensor, a second sensor, and a processor. After the rotation member rotates on the housing, the first sensor can detect the rotation position of the rotation member, and the second sensor can detect the rotation information of the rotation member. The processor performs corresponding operations according to the rotation position and/or the rotation information. The present application provides a solution for controlling the electronic device using the rotation member. When the user is inconvenient to use the screen or buttons to control the electronic device, the rotation member can be used to achieve control. Therefore, the present application controls the electronic device based on the information collected by the first sensor and the second sensor, which can improve the convenience of the device control. The present application also provides a control method for electronic device, which has the above beneficial effects, and will not be duplicated here.

### BRIEF DESCRIPTION OF DRAWINGS

In order to explain the technical solutions in the embodiments of the present application or in the prior art more clearly, the drawings needed to be used in the description of the embodiments or the prior art will be briefly introduced below. Obviously, the drawings in the following description are only part of the drawings of the present application. For those of ordinary skill in the art, other drawings can be obtained based on the provided drawings without exerting creative efforts.

FIG. 1 is a schematic structural diagram of an electronic device according to an embodiment of the present application;

FIG. 2 is a schematic diagram of a rotation member according to an embodiment of the present application;

FIG. 3 is a schematic structural diagram of a smart watch that supports multi-level rotating bezel detection according to an embodiment of the present application;

FIG. 4 is a schematic diagram of a gear mark of a housing according to an embodiment of the present application;

FIG. 5 is a flow chart of an MCU chip detecting bezel rotation through a three-axis Hall sensor according to an embodiment of the present application;

FIG. 6 is a schematic diagram of an optical tracking sensor collecting rotation information according to an embodiment of the present application;

FIG. 7 is a flow chart of a detection method for multi-level rotating bezel according to an embodiment of the present application;

FIG. 8 is a schematic diagram of the implementation of a bezel detection sensor according to an embodiment of the present application; and

FIG. 9 is a schematic structural diagram of a control method for an electronic device according to an embodiment of the present application.

### DETAILED DESCRIPTIONS

The technical solutions in the embodiments of the present application will be described below with reference to the accompanying drawings in the embodiments of the present application. Obviously, the described embodiments are only some of the embodiments of the present application, rather than all of the embodiments. Based on the embodiments in the present application, all other embodiments obtained by those of ordinary skill in the art without creative efforts fall within the scope of protection of the present application.

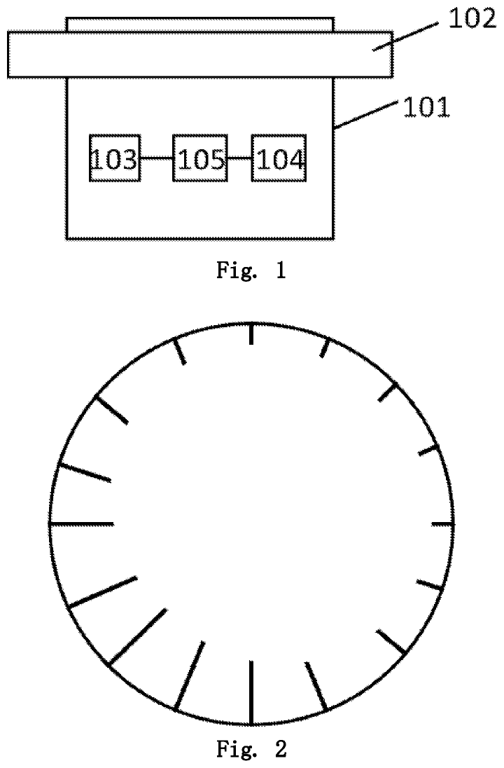

Please refer to FIG. 1 below. FIG. 1 is a schematic structural diagram of an electronic device according to an embodiment of the present application. The electronic device includes:
a housing 101;
a rotation member 102 rotatably connected to the housing 101;
a first sensor 103 configured to detect a rotation position of the rotation member 102;
a second sensor 104 configured to detect rotation information of the rotation member 102; wherein the rotation information includes any one of rotation direction, rotation angle and rotation speed, or any combination thereof;
a processor 105 respectively connected to the first sensor 103 and the second sensor 104 and configured to determine whether the rotation position is a preset position, and to perform a corresponding operation according to the rotation position and/or the rotation information.

The processor 105 in this embodiment can perform corresponding operations based on the current rotation position of the rotation member 102 when the rotation member 102 rotates to the preset position, can also perform corresponding operations based on the rotation information of the rotation member 102, and can also perform corresponding operations based on the rotation position and rotation information of the rotation member 102. The operations can be switching the display content, or controlling the volume, etc.

The electronic device according to this embodiment can be a wearable electronic device such as a mart watch, a smart bracelet, a smart ring, a smart necklace, a head-mounted display, smart glasses, etc., or can be a locator, a mobile phone, a smart speaker, a game controller, etc. The electronic device includes a housing, a rotation member, a first sensor, a second sensor, and a processor. After the rotation member rotates on the housing, the first sensor can detect the rotation position of the rotation member, and the second sensor can detect the rotation information of the rotation member. The processor performs corresponding operations according to the rotation position and/or the rotation information. This embodiment provides a solution for controlling the electronic device using the rotation member. When the user is inconvenient to use the screen or buttons to control the electronic device, the rotation member can be used to achieve control. Therefore, this embodiment controls the electronic device based on the information collected by the first sensor and the second sensor, which can improve the convenience of the device control.

Specifically, in the above embodiment, there may be no logical dependence between the operation of the first sensor detecting the rotation position and the operation of the second sensor detecting the rotation information; for example, after the electronic device is started, the first sensor and the second sensor may both be in operating state, that is, the first sensor always detects the rotation position, and the second sensor always detects the rotation information. In addition, in the above embodiment, there may also be a logical dependence between the operation of the first sensor detecting the rotation position and the operation of the second sensor detecting the rotation information; for example, the first sensor detects the rotation position first, and when a certain condition is met, the second sensor starts to detect the rotation information. The above condition may be receiving a rotation detection instruction sent by the processor, and the second sensor is configured to detect the rotation information of the rotation member after receiving the rotation detection instruction; wherein the rotation detection instruction is an instruction sent by the processor to the second sensor when the rotation position the rotation member is a preset position. Specifically, the above-mentioned processor is also configured to send a rotation detection instruction to the second sensor when the rotation position is a preset position; the second sensor detects the rotation information of the rotation member after receiving the rotation detection instruction. The second sensor does not detect the rotation information until receiving the rotation detection instruction; after receiving the rotation detection instruction, the second sensor starts the operation of detecting the rotation information of the rotation member, thereby reducing power consumption.

As a feasible implementation, the number of the above preset position is greater than 1. For example, the number of the preset position may be two, three or more.

As a feasible implementation, the above-mentioned processor can perform corresponding operations according to the rotation position in the following manner: determining whether the rotation position of the rotation member is the preset position; if the rotation position of the rotation member is the preset position, performing operations corresponding to the preset position. Correspondingly, the housing is provided with a gear mark, and the rotation member is provided with a rotation mark; the gear mark is configured to indicate whether the rotation mark is rotated to the preset position, so that the user can rotate the rotation member to the preset position according to the positional relationship between the rotation mark and the gear mark. Optionally, the position of the gear mark on the housing corresponds to the preset position, when the rotation member rotates to the preset position, the rotation mark points to the gear mark corresponding to the preset position. The number of the gear mark may be equal to the number of the preset position. When there are two preset positions, two gear marks are provided on the housing and they correspond to the two preset positions respectively. When the rotation member rotates to one of the preset positions, the rotation mark points to the gear mark corresponding to the preset position.

As a further introduction to the embodiment corresponding to FIG. 1, the first sensor can determine the rotation position of the rotation member through the intensity of the magnetic field. Specifically, the rotation member is provided with a magnetic component, and the first sensor is a magnetic sensor. The magnetic sensor can be a Hall sensor. Furthermore, in order to reduce the number of the magnetic component, the magnetic sensor may be a three-axis Hall sensor. The first sensor may also be a mechanical switch, an image sensor, an optical tracking sensor, etc.

As a further introduction to the embodiment corresponding to FIG. 1, the second sensor can determine the rotation information of the rotation member through optical signals. Specifically, the second sensor is an optical tracking sensor. A circle of reference line can be set on the corresponding rotation member, the optical tracking sensor can determine the rotation direction, rotation angle and rotation speed based on the collected image information. FIG. 2 is a schematic diagram of a rotation member according to an embodiment of the present application. As shown in FIG. 2, an edge of the rotation member is provided with multiple reference lines with the same intervals, each reference line has a different length. The optical tracking sensor can determine the rotation information based on changes in the currently detected reference line length. The second sensor may also be an image sensor, a magnetic sensor, or the like.

As a further introduction to the corresponding embodiment of FIG. 1, the process of the processor performing corresponding operations based on the rotation position and/or rotation information includes: determining whether the rotation position is a preset position; if so, controlling the display to display an application menu corresponding to the preset position; wherein the application menu includes multiple application icons; and/or, obtaining the rotation information collected by the second sensor, and adjusting the currently selected application icon in the screen of the display according to the rotation information.

If the rotation position is not the preset position after determining whether the rotation position is the preset position, the processor is controlled to enter a sleep state, and the first sensor is controlled to enter a low power consumption detection mode, thereby reducing the power consumption of the electronic device.

Further, if an application start instruction is received after adjusting the selected application icon in the display screen according to the rotation information, an application corresponding to the currently selected application icon in the display screen is started; and/or, if the rotation information does not change within a preset time, an application corresponding to the currently selected application icon in the display screen is started.

The electronic device described in the above embodiment is described hereinafter by taking a smart watch in practical application as an example.

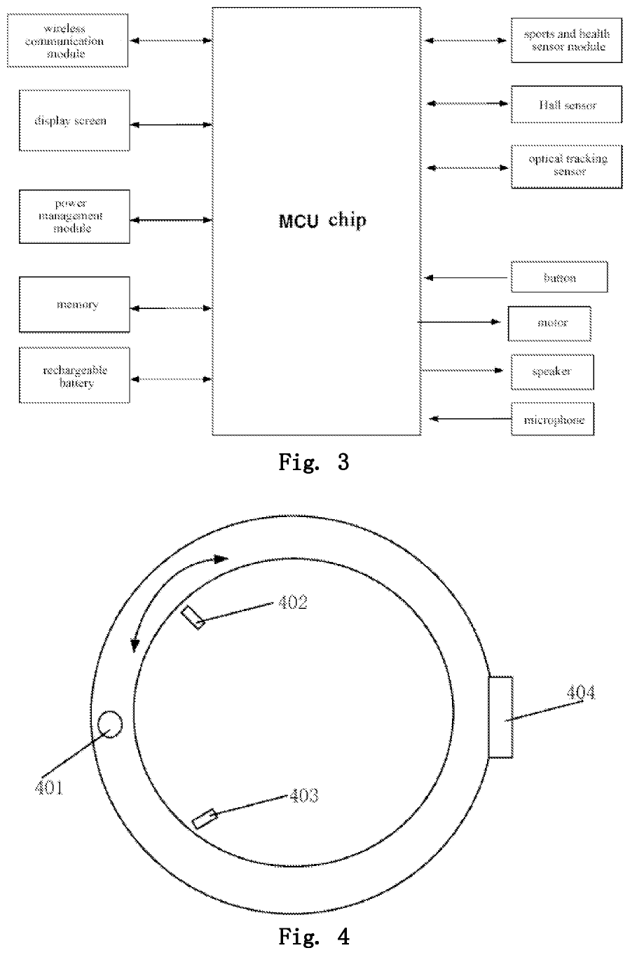

Please refer to FIG. 3. FIG. 3 is a schematic structural diagram of a smart watch that supports multi-level rotating bezel detection according to an embodiment of the present application. Taking the electronic device being a smart watch as an example, the rotation member is a bezel provided with a magnetic component. The bezel is rotatably disposed outside a part of the housing. The first sensor is a Hall sensor, the second sensor is an optical tracking sensor, and the processor is a Microcontroller Unit (MCU) chip of the smart watch. The Hall sensor can detect the rotation position of the bezel, and the optical tracking sensor can detect the rotation information of the bezel. The rotation information may include rotation angle, rotation direction and rotation speed; the MCU chip is a computing control part of the smart watch, can complete operations such as fetching instructions, executing instructions, and exchanging information with external memory and logic components.

The smart watch shown in FIG. 3 further includes a graphics processor, a wireless communication module, a display screen, a power management module, a memory, a rechargeable battery, a sports and health sensor module, a button, a motor, a speaker, a microphone, etc. The graphics processor can draw graphics content and drive the display screen for graphics display. The wireless communication module can be, but is not limited to, a Bluetooth module, a WiFi module, a 4G mobile communication module, etc. The smart watch can be connected to an external device (such as a mobile phone) or network (such as the Internet) through this module. The memory can store various applications and related data. The display screen can display the display information of the system processing module, such as pictures, videos, UI interfaces, etc. The sports and health sensor module includes, but is not limited to, an acceleration sensor, a gyroscope, a heart rate sensor, etc. The sports and health sensor module is configured to detect the user's motion data and health data.

Furthermore, the housing and the display screen can be fixed components on the smart watch. The bezel is assembled to the housing through a positioning connection mechanism such as a buckle, and the bezel can rotate relative to the housing and the display screen. A rotation mark may be provided on the bezel to indicate the rotation position of the bezel; a gear mark may be provided on the cover glass or the housing of the display screen to indicate the rotation position of the bezel relative to the housing. Please refer to FIG. 4. FIG. 4 is a schematic diagram of a gear mark of a housing according to an embodiment of the present application. There are two preset positions and two corresponding gear marks. In FIG. 4, 401 is a rotation mark of the bezel, 402 is a first gear mark of the housing, 403 is a second gear mark of the housing, and 404 is a button of the housing.

When the user rotates the bezel, the Hall sensor can detect changes in the environmental magnetic field data and send an interrupt signal to the MCU chip when the change in the environmental magnetic field data is greater than a preset value. After the MCU chip detects the interrupt signal sent by the Hall sensor, it reads the current magnetic field data from the Hall sensor, so as to determine whether the rotation mark of the bezel rotates to a preset position corresponding to the first gear mark or the second gear mark according to the current magnetic field data. When it is detected that the rotation mark on the bezel rotates to the preset position corresponding to the first gear mark or the second gear mark, the MCU chip can control the display screen to display a first-level application menu in the display screen. At this time, the MCU chip may also send a rotation detection instruction to the optical tracking sensor to start the optical tracking sensor to detect the rotation information of the bezel. The MCU chip can adjust the currently selected application icon in the display screen based on the rotation information detected by the optical tracking sensor on the bezel. The above-mentioned rotation information may include rotation angle, rotation direction and rotation speed, and the MCU chip can adjust the currently selected application icon in the display screen according to the rotation angle, rotation direction and rotation speed. When the user stays on the selected application icon for more than the preset time, or presses a button after selecting the application icon, the MCU chip starts the selected application and controls the display screen to display the corresponding application interface or a second-level application menu.

An example of the process of displaying the application menu and starting the selected application as above is as follows. When the rotation mark on the bezel rotates to the first gear mark, the MCU chip can control the display screen to display a first-level health menu in the display screen. The first-level health menu includes application icons such as heart rate, blood oxygen, electrocardiogram, blood pressure, body fat, etc. After the bezel rotates to the first gear mark, the optical tracking sensor is started to detect the rotation information, and the MCU chip adjusts the currently selected application icon in the display screen based on the rotation information. The above selected application icon may be one of application icons such as heart rate, blood oxygen, electrocardiogram, blood pressure, body fat, etc. If the user stays for more than 1 second after selecting the heart rate application icon, the MCU chip starts the selected heart rate application and controls the display to display the corresponding heart rate application interface.

As a feasible implementation, the Hall sensor in the above-mentioned smart watch may be a three-axis Hall sensor. The three-axis Hall sensor is placed on a motherboard under the bezel. A magnet may be embedded in a specific position in the bezel. As the magnet rotates by rotating the bezel, the magnetic field data collected by the three-axis Hall sensor changes, thereby enabling the detection of the rotation position of the bezel. The three-axis Hall sensor can detect changes in the magnetic fields of surrounding three axes X, Y, and Z, and generate an interrupt signal to the MCU chip based on the set magnetic field change threshold. The minimum change in single-axis magnetic induction intensity that the three-axis Hall sensor can detect is 3 uT.

Furthermore, in this embodiment, magnets can be embedded in the bezel according to the number and position of the trigger gears, and the size, position and number of magnets, and the placement position of the three-axis Hall sensor on the motherboard can also be adjusted according to actual application requirements. For example, if the gear mark of the housing includes the default gear mark corresponding to the 9 o'clock position, the first gear mark corresponding to 11 o'clock, and the second gear mark corresponding to 7 o'clock, the three-axis Hall sensor can be placed near the projection of the default gear mark on the motherboard. The size, number and position of magnets will all affect the magnetic induction intensity around the three-axis Hall sensor. Therefore, in this embodiment, the size, number and position of magnets can be adjusted so that the magnetic induction intensities of the three axes X, Y, and Z have significant differences when the three-axis Hall sensor detects that the rotation mark rotates to each of the default gear mark, the first gear mark and the second gear mark.

As a feasible implementation, in this embodiment, one large magnet can be buried at the 9 o'clock position of the bezel, and multiple small magnets can be buried between 7 and 11 o'clock positions. This embodiment can calibrate the magnetic field triggering threshold, triggering area and accidental triggering prevention threshold at three positions: 7 o'clock, 9 o'clock, and 11 o'clock positions. The magnetic field triggering threshold refers to a magnetic field intensity threshold that determines when the bezel's rotation mark rotates to a certain gear mark. The triggering area refers to an area corresponding to the bezel's rotation position that determines when the bezel's rotation mark rotates to a certain gear mark (for example, if the rotation mark of the bezel points to the area from 6:40 to 7:20, it is determined that the rotation mark has rotated to the second gear mark corresponding to 7 o'clock). The accidental triggering prevention threshold is a safety margin set to prevent confusion in the identification of multiple gear marks. Taking the second gear mark corresponding to 7 o'clock as an example, it can mark the magnetic induction intensities of the three axes X, Y, Z on the 20-minute positions on each of the left and right sides of the second gear mark corresponding to 7 o'clock. That is, the magnetic induction intensities of the three axes X, Y, Z at the 7:20 position are M720x, M720y, and M720z, and those at the 6:40 position are M640x, M640y, and M640z. In the same way, it can mark the magnetic induction intensities of the three axes X, Y, Z on the 20-minute positions on each of the left and right sides of the default gear mark corresponding to 9 o'clock. The magnetic induction intensities of the three axes X, Y, Z at the 9:20 position are M920x, M920y, and M920z, and those at the 8:40 position are M840x, M840y, and M840z. To prevent accidental triggering, the magnetic size and magnetic position are adjusted so that there is a sufficient safety margin between the magnetic induction intensity at the 8:40 position and the magnetic induction intensity at the 7:20 position detected by the three-axis Hall sensor. That is: |M840x−M720x|>ΔMx, |M840y−M720y|>ΔMy, |M840z−M720z|>ΔMz. In this embodiment, ΔMx=ΔMy=ΔMz=200 uT. ΔMx is the X-axis safety margin, ΔMy is the Y-axis safety margin, and ΔMz is the Z-axis safety margin.

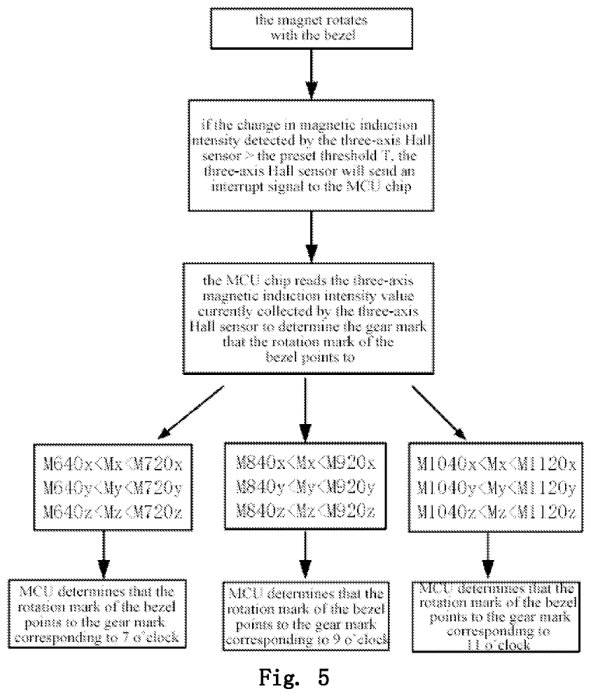

Please refer to FIG. 5. FIG. 5 is a flow chart of an MCU chip detecting bezel rotation through a three-axis Hall sensor according to an embodiment of the present application. The specific process is as follows: the magnet rotates with the bezel, if a change in magnetic induction intensity detected by the three-axis Hall sensor is greater than a preset threshold T, the three-axis Hall sensor will send an interrupt signal to the MCU chip to wake up the MCU chip. The MCU chip reads the three-axis magnetic induction intensity value currently collected by the three-axis Hall sensor to determine the gear mark that the rotation mark of the bezel points to. If M640x<Mx<M720x, M640y<My<M720y, and M640z<Mz<M720z, it is determined that the rotation mark of the bezel points to the second gear mark corresponding to 7 o'clock, and the MCU chip can control the display screen to display the first-level application menu M1, and detects the application selected by the user in the menu. If M840x<Mx<M920x, M840y<My<M920y, and M840z<Mz<M920z, it is determined that the rotation mark of the bezel points to the default gear mark corresponding to 9 o'clock. At this time, the MCU chip enters a sleep state, and the three-axis Hall sensor enters a low power consumption detection mode. If M1040x<Mx<M1120x, M1040y<My<M1120y, and M1040z<Mz<M1120z, it is determined that the rotation mark of the bezel points to the first gear mark corresponding to 11 o'clock, and the MCU chip can control the display screen to display the first-level application menu M2, and detects the application selected by the user in the menu. Detecting the application selected by the user in the menu can be achieved by rotating buttons or by touch screen. Mx is the current magnetic induction intensity of the X-axis, My is the current magnetic induction intensity of the Y-axis, and Mz is the current magnetic induction intensity of the Z-axis.

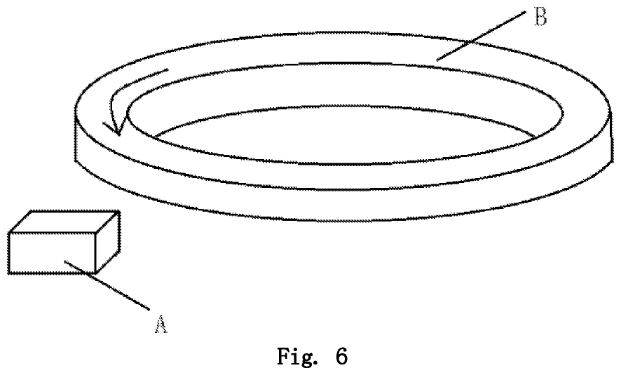

The optical tracking sensor has a built-in laser light source and an image sensor, can detect the rotation direction, rotation speed and rotation angle of a smooth plane. The optical tracking sensor can be placed on an edge of the motherboard, in an area facing the bezel. A part of the housing above the optical tracking sensor can be made of transparent plastic to allow the laser light to smoothly penetrate and illuminate the rotating bezel. The optical tracking sensor can receive the laser light reflected back by the bezel. Please refer to FIG. 6. FIG. 6 is a schematic diagram of an optical tracking sensor collecting rotation information according to an embodiment of the present application. In FIG. 6, A is the optical tracking sensor and B is the bezel. The rotating surface under the bezel is a smooth plane, for example, the surface roughness can be 0.5 um˜1 um.

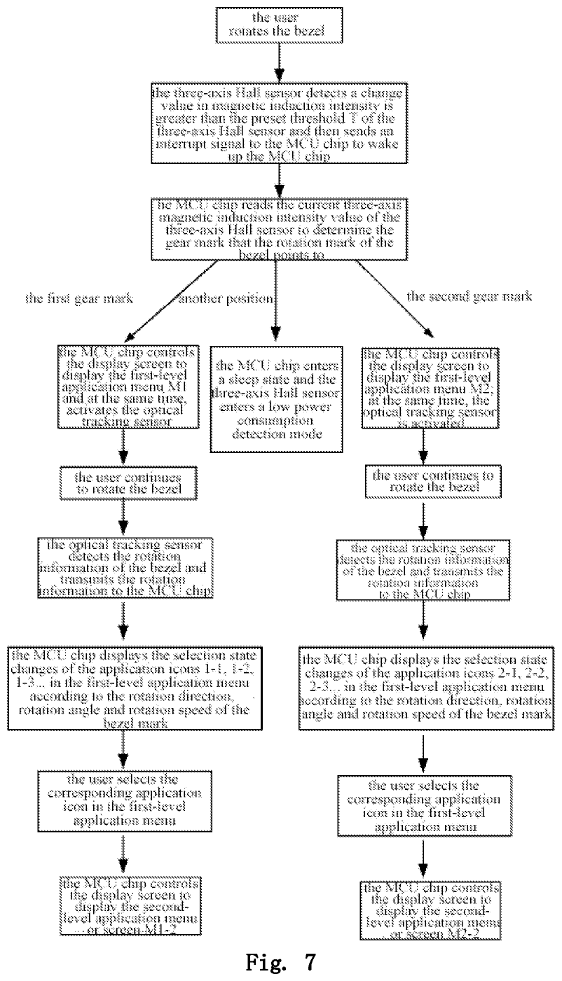

Please refer to FIG. 7. FIG. 7 is a flow chart of a detection method for multi-level rotating bezel according to an embodiment of the present application. The process includes the following steps: the user rotates the bezel, and after the three-axis Hall sensor detects that the change value in magnetic induction intensity is greater than the preset threshold T of the three-axis Hall sensor, the three-axis Hall sensor sends an interrupt signal to the MCU chip to wake up the MCU chip. The MCU chip reads the current three-axis magnetic induction intensity value of the three-axis Hall sensor to determine the gear mark that the rotation mark of the bezel points to. If the rotation mark on the bezel points to the first gear mark, the MCU chip controls the display screen to display the first-level application menu M1 and at the same time, activates the optical tracking sensor. The user continues to rotate the bezel, and the optical tracking sensor detects the rotation information of the bezel and transmits the rotation information to the MCU chip. The MCU chip displays the corresponding selection state changes of the application icons 1-1, 1-2, 1-3 . . . in the first-level application menu according to the rotation direction, rotation angle and rotation speed of the bezel mark. The user selects the corresponding application icon in the first-level application menu, and the MCU chip controls the display screen to display the second-level application menu or screen M1-2. If the rotation mark on the bezel points to the second gear mark, the MCU chip controls the display screen to display the first-level application menu M2; at the same time, the optical tracking sensor is activated. The user continues to rotate the bezel, and the optical tracking sensor detects the rotation information of the bezel and transmits the rotation information to the MCU chip. The MCU chip displays the corresponding selection state changes of the application icons 2-1, 2-2, 2-3 . . . in the first-level application menu according to the rotation direction, rotation angle and rotation speed of the bezel mark. The user selects the corresponding application icon in the first-level application menu, and the MCU chip controls the display screen to display the second-level application menu or screen M2-2. If the bezel is in another position, the MCU chip enters a sleep state and the three-axis Hall sensor enters a low power consumption detection mode.

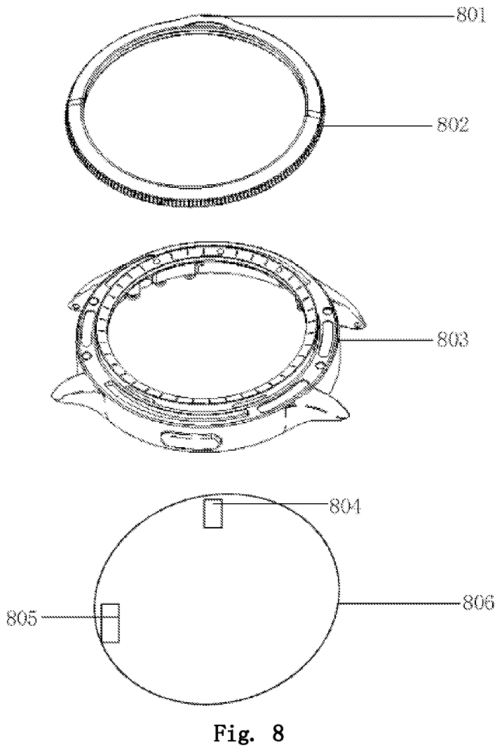

Please refer to FIG. 8. FIG. 8 is a schematic diagram of the implementation of a bezel detection sensor according to an embodiment of the present application. In FIG. 8, 801 is a magnet embedded in the bezel, 802 is a bezel, 803 is a frame, 804 is a three-axis Hall sensor, 805 is an optical tracking sensor, and 806 is a motherboard. As shown in FIG. 8, the three-axis Hall sensor together with the magnet embedded in a fixed position of the bezel can achieve absolute position detection.

The outer bezel of the display screen of the smart watch according to the above embodiment can be rotated. Different sensors are used inside the watch to detect the rotation angle, rotation direction and rotation speed of the bezel. Users can switch and operate multi-level menus by simply rotating the bezel without operating the touch screen. The three-axis Hall sensor detects the rotation position, and the optical tracking sensor detects the continuous rotation information of the bezel. The three-axis Hall sensor detects that the bezel rotates to a predetermined position, and the MCU chip controls the display screen to display the first-level menu list. The user continues to rotate the bezel, and the MCU chip changes the selection state of the second-level application object in the menu list based on the rotation information detected by the second sensor. The present application provides a solution for using the bezel to control a smart watch. When the user is inconvenient to use the screen or buttons to control the smart watch, the bezel can be used to achieve control, which can improve the convenience of the user to control the smart watch.

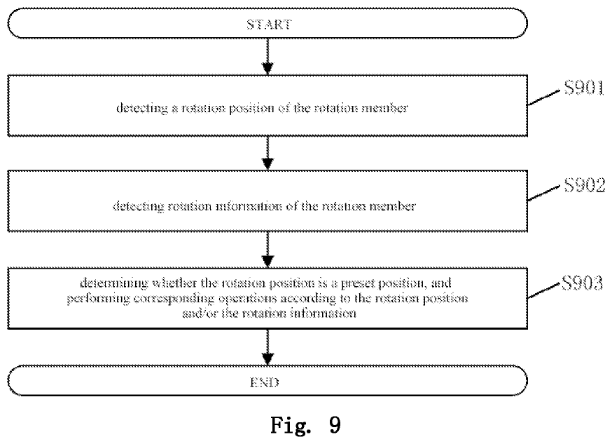

Please refer to FIG. 9. FIG. 9 is a schematic structural diagram of a control method for an electronic device according to an embodiment of the present application. The electronic device includes a housing and a rotation member rotatably connected to the housing. The control method includes the following steps:
S901: detecting a rotation position of the rotation member;
S902: detecting rotation information of the rotation member; wherein the rotation information includes any one of rotation direction, rotation angle and rotation speed, or any combination thereof;
S903: determining whether the rotation position is a preset position, and performing corresponding operations according to the rotation position and/or the rotation information.

The electronic device provided in this embodiment includes a housing, a rotation member, a first sensor, a second sensor, and a processor. After the rotation member rotates on the housing, the first sensor can detect the rotation position of the rotation member, and the second sensor can detect the rotation information of the rotation member. The processor performs corresponding operations according to the rotation position and/or the rotation information. The present embodiment provides a solution for controlling the electronic device using the rotation member. When the user is inconvenient to use the screen or buttons to control the electronic device, the rotation member can be used to achieve control. Therefore, the present embodiment controls the electronic device based on the information collected by the first sensor and the second sensor, which can improve the convenience of the device control.

Furthermore, the method further includes:
when the rotation position is the preset position, sending a rotation detection instruction to the second sensor, so that the second sensor detects the rotation information of the rotation member after receiving the rotation detection instruction.

Further, the housing is provided with a gear mark, and the rotation member is provided with a rotation mark; wherein the gear mark is configured to indicate whether the rotation mark is rotated to the preset position.

Further, the number of the preset position is greater than one.

Further, the rotation member is provided with a magnetic component; and correspondingly, the first sensor is a magnetic sensor.

Further, the magnetic sensor is a three-axis Hall sensor.

Further, the second sensor is an optical tracking sensor.

Further, the electronic device is a smart watch, the rotation member is a bezel, and the bezel is rotatably disposed outside a part of the housing.

Further, a process of performing corresponding operations according to the rotation position and/or the rotation information includes:
determining whether the rotation position is a preset position; if so, controlling the display to display an application menu corresponding to the preset position; wherein the application menu includes multiple application icons; and/or
obtaining the rotation information collected by the second sensor, and adjusting the currently selected application icon in the display screen of the display according to the rotation information.

Furthermore, the method further includes: after determining whether the rotation position is the preset position,
when the rotation position is not the preset position, controlling the processor to enter a sleep state, and controlling the first sensor to enter a low power consumption detection mode.

Furthermore, the method further includes: after adjusting the selected application icon in the display screen according to the rotation information,
if an application start instruction is received, starting an application corresponding to the currently selected application icon in the display screen; and/or,
if the rotation information does not change within a preset time, starting an application corresponding to the currently selected application icon in the display screen.

Since the embodiments of the method correspond to the embodiments of the device, for the embodiments of the method section, please refer to the description of the embodiments of the device, and it will not be duplicated here.

The present application also provides a storage medium on which a computer program is stored. When the computer program is executed, the steps provided in the above embodiments can be implemented. The storage medium may include: USB disk, mobile hard disk, read-only memory (ROM), random access memory (RAM), magnetic disk or optical disk and other media that can store program codes.

A control system for an electronic device is provided according to an embodiment of the present application; the electronic device includes a housing and a rotation member rotatably connected to the housing. The control system includes:
a position detection module configured to detect a rotation position of the rotation member;
a rotation information detection module configured to detect rotation information of the rotation member; wherein the rotation information includes any one of rotation direction, rotation angle and rotation speed, or any combination thereof; and
a control module configured to determine whether the rotation position is a preset position, and to perform corresponding operations based on the rotation position and/or rotation information.

Each embodiment in the specification is described in a progressive manner. Each embodiment focuses on its differences from other embodiments. The same and similar parts between the various embodiments can be referred to each other. As for the system disclosed in the embodiment, since it corresponds to the method disclosed in the embodiment, the description is relatively simple. For relevant details, please refer to the description in the method section. It should be noted that for those of ordinary skill in the art, several improvements and modifications can be made to the present application without departing from the principles of the present application, and these improvements and modifications also fall within the protection scope of the claims of the present application.

It should also be noted that in this specification, relational terms such as first and second are only configured to distinguish one entity or operation from another entity or operation, and do not necessarily require or imply that these entities or operations have such actual relationship or sequence between them. Furthermore, the terms “comprise”, “include” or any other variations thereof are intended to cover a non-exclusive inclusion such that a process, method, article, or device that comprises a list of elements comprises not only those elements, but also other elements not expressly listed, or elements inherent to the process, method, article or device. Without further limitation, an element defined by the statement “comprises a . . . ” does not exclude the presence of additional identical elements in the process, method, article, or device that comprises the stated element.

1. An electronic device, comprising:
a housing;
a rotation member rotatably connected to the housing;
a first sensor configured to detect a rotation position of the rotation member;
a second sensor configured to detect rotation information of the rotation member, wherein the rotation information comprises any one of a rotation direction, a rotation angle and a rotation speed, or any combination thereof; and
a processor respectively connected to the first sensor and the second sensor and configured to determine whether the rotation position is a preset position, and to perform a corresponding operation according to the rotation position and/or the rotation information.

2. The electronic device according to claim 1, wherein the processor is further configured to send a rotation detection instruction to the second sensor when the rotation position is the preset position, and
wherein the second sensor is configured to detect the rotation information of the rotation member after receiving the rotation detection instruction.

3. The electronic device according to claim 1, wherein the housing is provided with a gear mark, and the rotation member is provided with a rotation mark, wherein the gear mark is configured to indicate whether the rotation mark is rotated to the preset position.

4. The electronic device according to claim 1, wherein the number of the preset position is greater than one.

5. The electronic device according to claim 1, wherein the rotation member is provided with a magnetic component, and correspondingly, the first sensor is a magnetic sensor.

6. The electronic device according to claim 5, wherein the magnetic sensor is a three-axis Hall sensor.

7. The electronic device according to claim 1, wherein the second sensor is an optical tracking sensor.

8. The electronic device according to claim 1, wherein the electronic device is a smart watch, the rotation member is a watch bezel, and the watch bezel is rotatably disposed outside a part of the housing.

9. The electronic device according to claim 1, wherein the processor is further configured to control the processor to enter a sleep state and control the first sensor to enter a low power consumption detection mode when the rotation position is not the preset position.

10. The electronic device according to claim 1, wherein the electronic device further comprises a display, and
wherein a process for the processor to perform the corresponding operation according to the rotation position and/or the rotation information comprises:
determining whether the rotation position is the preset position, if so, controlling the display to display an application menu corresponding to the preset position, wherein the application menu comprises multiple application icons; and/or
obtaining the rotation information collected by the second sensor, and adjusting the currently selected application icon in a display screen of the display according to the rotation information.

11. The electronic device according to claim 10, wherein after the processor adjusting the selected application icon in the display screen according to the rotation information, the performed operation further comprises:
if an application start instruction is received, starting an application corresponding to the currently selected application icon in the display screen; and/or
if the rotation information does not change within a preset time, starting the application corresponding to the currently selected application icon in the display screen.

12. A control method for an electronic device, wherein the electronic device comprises a housing and a rotation member rotatably connected to the housing, the control method comprising:
detecting a rotation position of the rotation member;
detecting rotation information of the rotation member, wherein the rotation information comprises any one of a rotation direction, a rotation angle and a rotation speed, or any combination thereof; and
determining whether the rotation position is a preset position, and performing a corresponding operation according to the rotation position and/or the rotation information.
